(19) United States
(12) Patent Application Publication
(10) Pub. No.: US 2007/0013825 A1
(43) Pub. Date: Jan. 18, 2007

(54) Liquid crystal display

(75) Inventors: Choong-sik Kim, Gyeonggi-do (KR); Dae-yoon Jung, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/478,795

(22) Filed: Jun. 29, 2006

(30) Foreign Application Priority Data
Jun. 29, 2005 (KR) 2005-0056794

(51) Int. Cl. G02F 1/1333

(52) U.S. Cl. 349/58

(57) ABSTRACT

A liquid crystal display (LCD) that is capable of improving light efficiency and brightness uniformity is disclosed. The LCD includes: an LCD panel forming an image; a lamp unit irradiating the back of the LCD panel; a bottom casing accommodating the lamp unit and including a plurality of mounting parts; and a lamp supporting member. The lamp supporting member is made with a bent wire and includes a lamp holder that is shaped into a partial loop to hold the lamp unit. The lamp supporting member also includes a fixing part that is configured to be coupled with the mounting part.

### CROSS-REFERENCE TO RELATED APPLICATIONS

This application claims the benefit of Korean Patent Application No. 2005-0056794, filed on Jun. 29, 2005 in the Korean Intellectual Property Office, the disclosure of which is incorporated herein by reference.

### BACKGROUND OF THE INVENTION

1. Field of the Invention

The present invention relates to a liquid crystal display, and more particularly, to a liquid crystal display using a lamp supporting member to support a lamp unit.

2. Description of the Related Art

A liquid crystal display (LCD) is a device for displaying an image, with liquid crystal cells arranged in a matrix. Light transmittance through each of the liquid crystal cells is adjusted according to an image signal. The LCD forms an image on an LCD panel using light from a backlight unit.

The LCD comprises an LCD panel, which includes liquid crystal cells forming a pixel unit are arranged in a matrix formation, a driving part driving the liquid crystal cells, and a backlight unit providing light to the LCD panel uniformly. The backlight unit includes an optical sheet disposed behind the LCD panel, a lamp unit capable of supplying light to the LCD panel, and a lamp supporting member supporting the lamp unit.

Typically, the lamp supporting member includes a fixing part that is inserted into a mounting part, a supporting plate extending from the fixing part, and a lamp holder protruding toward the lamp unit from the supporting plate. There are usually multiple mounting parts formed in a bottom casing.

The lamp supporting member is made of thick plastic to maintain firmness and rigidity. However, the thick lamp supporting member blocks the light from the lamp unit, thereby decreasing light efficiency and brightness uniformity. A lamp supporting member that can provide the desired rigidity without adversely affecting the display panel's brightness is desired.

### SUMMARY OF THE INVENTION

Accordingly, it is an aspect of the present invention to provide an LCD which is improved in light efficiency and brightness uniformity.

In one aspect, the invention is a liquid crystal display (LCD) including an LCD panel forming an image, a lamp unit irradiating the LCD panel, a bottom casing capable of receiving the lamp unit and having a mounting part, and a lamp supporting member. The lamp supporting member includes a lamp holder that is made with a long wire shaped into a partial loop to hold the lamp unit. The lamp supporting member includes a long partial loop to hold the lamp unit, and a fixing part configured to be coupled with the mounting part.

In yet another aspect, the invention is a liquid crystal display (LCD) that has a lamp unit, a bottom casing having a mounting part, and a lamp supporting member made of a single piece of wire. The wire is bent to form a loop for holding the lamp unit and a fixing part to securely attach to the mounting part.

In yet another aspect, the invention is a method of making a liquid crystal display (LCD). The method entails providing a lamp unit, providing a bottom casing having a mounting part, and fixing the lamp unit to the bottom casing by using a lamp supporting member. The lamp supporting member is made of a single piece of wire that is bent to form a loop for holding the lamp unit and a fixing part to securely attach to the mounting part.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is an exploded perspective view of an LCD according to a first embodiment of the present invention;

FIG. 2 is a sectional view of the LCD according to the first embodiment of the present invention;

FIG. 3 is a sectional view of a main part of the LCD according to the first embodiment of the present invention;

FIG. 4 is a sectional view of a main part of an LCD according to a second embodiment of the present invention;

FIG. 5 is a sectional view of a main part of an LCD according to a third embodiment of the present invention; and

FIG. 6 is a sectional view of a main part of an LCD according to a fourth embodiment of the present invention.

### DETAILED DESCRIPTION OF THE EMBODIMENT(S)

Reference will now be made in detail to exemplary embodiments of the present invention, examples of which are illustrated in the accompanying drawings. Like reference numerals refer to like elements throughout. The embodiments are described below in order to explain the present invention by referring to the Figures.

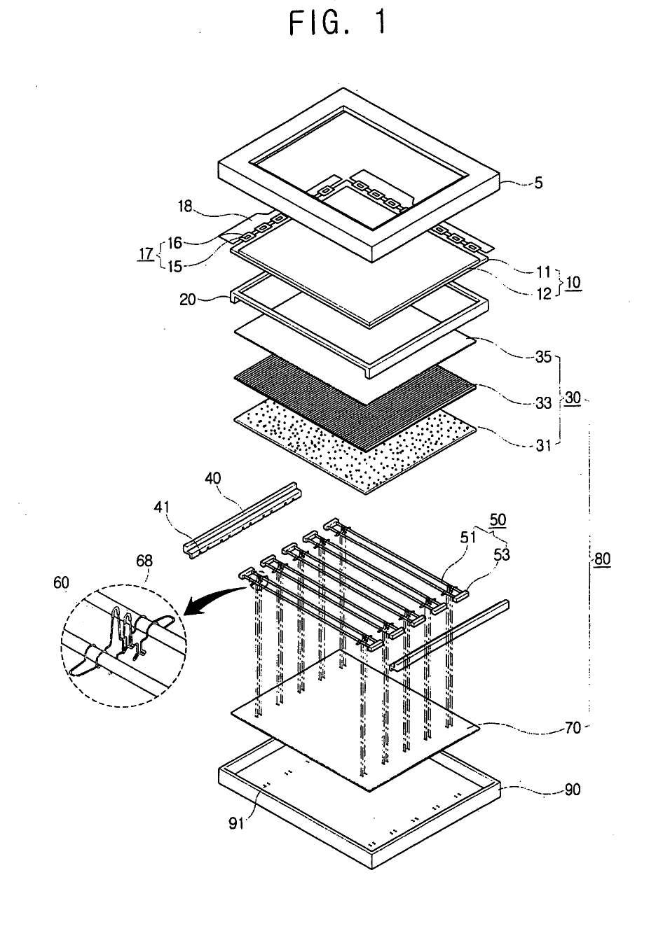

Hereinafter, a first embodiment of the present invention will be described in detail with reference to FIGS. 1 through 3.

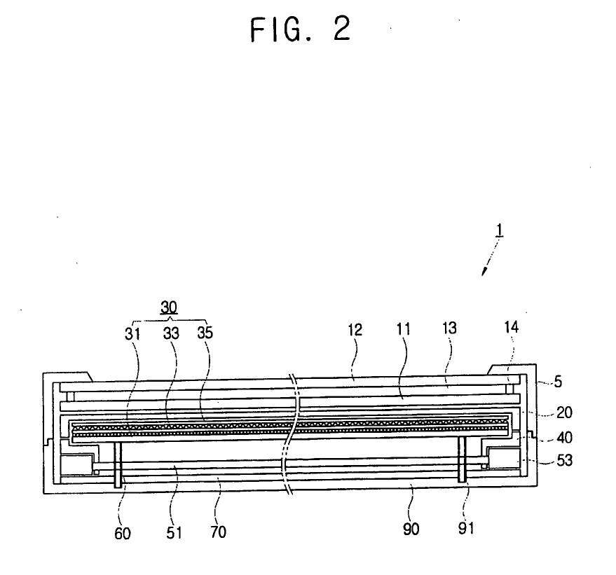

As shown in FIGS. 1 and 2, an LCD 1 according to a first embodiment of the present invention includes an LCD panel 10, a driving part 17, a middle mold 20, a backlight unit 80, a bottom casing 90 and a top casing 5. The LCD panel forms an image thereon according to signals from the driving part 17 that drives the LCD panel 10. The middle mold 20 supports the edges of the LCD panel 10 and the backlight unit 80 irradiates the back of the LCD panel 10. The bottom casing 90 accommodates the backlight unit 80 and combines with the top casing 5, which covers a front surface of the LCD panel 10.

The LCD panel 10 has a thin film transistor (TFT) substrate 11, a color filter substrate 12 positioned substantially parallel to the TFT substrate 11, and a liquid crystal layer 13 interposed between the TFT substrate 11 and the color filter substrate 12. The LCD panel 10 includes liquid crystal cells that form a pixel unit. The liquid crystal cells are arranged in a matrix formation. The light transmittance through each of the cells is adjusted according to an image signal transmitted from the driving part 17 so that a desired image is portrayed collectively by the liquid crystal cells.

A plurality of gate lines and data lines are provided in the form a grid on the TFT substrate 11. A TFT is formed at an intersection of a gate line and a data line. A signal voltage transmitted from the driving part 17 is applied to a pixel electrode and a common voltage is applied to a common electrode, thus forming an electric field between the pixel electrode and the common electrode on the color filter substrate 12 through the TFT. The liquid crystal 13 between the pixel electrode and the common electrode is arranged according to the signal voltage, thereby determining the light transmittance.

The color filter substrate 12 includes a color filter and the common electrode, wherein the color filter has red, green and blue filters or cyan, magenta and yellow filters that are repeatedly formed within the confines of a black matrix. The common electrode comprises a transparent conductive material such as indium tin oxide (ITO) or indium zinc oxide (IZO). The color filter substrate 12 has a smaller area than the TFT substrate 11.

A sealant 14 adheres the TFT substrate 11 to the color filter substrate 12, and the liquid crystal is interposed between the two substrates.

The LCD panel 10 also includes polarizing plates (not shown). At least one polarizing plate is adhered to a front surface of the color filter substrate 12 and at least one polarizing plate is adhered to a rear surface of the TFT substrate 11 so that light transmitted to the LCD panel 10 is polarized in different directions. The polarization direction of the front polarizing plate is orthogonal to the polarization direction of the rear polarizing plate. The rear polarizing plate polarizes light incident to the LCD panel 10 and the front polarizing plate functions as an analyzer.

The driving part 17 comprises a driving chip 15 and a flexible printed circuit (FPC) 16. The driving chip 15, which applies a driving signal to the LCD panel 10, is seated on the FPC 15 in a chip on film (COF) type. The FPC 16 is connected to an end portion of a gate line or an end portion of a data line of the TFT substrate 11. The driving part 17 extends to the rear of the bottom casing 90 with the FPC 16 bent. The liquid crystal 13 disposed between the TFT substrate 11 and the color filter substrate 12 receives the driving signal from the driving part 17 and reorients itself in response to the driving signal.

The driving part 17 shown in FIG. 1 is a chip on film (COF) type. However, any well-known type, such as a tape carrier package (TCP), a chip on glass (COG) or the like, may be used as the driving part. Further, the driving part 17 may be formed on the TFT substrate 11 during a wiring process.

A driving circuit part 18 is a circuit board comprising a circuit pattern thereon to control the driving part 17. The driving circuit part 18 is connected to one side of the driving part 17 extending to the rear of the bottom casing 90, thereby being disposed in back of the bottom casing 90.

The middle mold 20 of a rectangular shape is formed along the edges of the LCD panel 10 and spaces the LCD panel 10 apart from the backlight unit 80.

The backlight unit 80 comprises an optical sheet 30, a lamp unit 50, a side mold 40, a lamp supporting member 60 and a reflecting sheet 70. The optical sheet 30 is disposed behind the LCD panel 10 and the lamp unit 50 irradiates the rear of the LCD panel through the optical sheet 30. The side mold 40 separates the lamp unit 50 from the optical sheet 30 and supports them. The lamp supporting member 60 is fixed to the bottom casing 90 and supports the lamp unit 50. The reflecting sheet 70 is disposed between the lamp unit 50 and the bottom casing 90, thereby diffusing the light from the lamp unit 50 uniformly to propagate to the rear of the LCD panel 10.

The optical sheet 30 comprises a protection sheet 31, a prism sheet 33 and a diffusion sheet 35 which are disposed on the back of the LCD panel 10. The diffusion sheet 35 includes a base plate and,a coating layer having beads formed on the base plate. The diffusion sheet 35 diffuses light from the lamp unit 50 and provides it to the LCD panel 10. Two or three diffusion sheets may be layered to form the diffusion sheet 35. The prism sheet 33 includes triangular prisms arranged in a predetermined manner. The prism sheet 33 collects the light diffused by the diffusion sheet 35, the diffusion happening in a direction that is perpendicular to a surface of the LCD panel 20. Typically, two prism sheets 33 are used and micro prisms formed on each prism sheet 33 make an angle with each other. The light passing through the prism sheet 33 mostly continues in the direction that is perpendicular to the surface of the prism sheet 33, thereby forming a uniform brightness distribution. The protection sheet 31 disposed on the optical sheet 30 protects the prism sheet 33 and prevents it from becoming scratched.

The lamp unit 50 comprises a lamp 51 emitting light, a lamp electrode (not shown) formed at an end portion of the lamp 51 and a lamp supporting part 53 into which the end portion of the lamp 51 is inserted. The lamp unit 50 is supplied with electric power from an inverter (not shown) to be driven. A plurality of the lamp units 50 are disposed parallel to each other behind the LCD panel 10. The lamp 51 is inserted into the lamp supporting part 53 in a pair. The lamp supporting part 53 holds the ends of the lamp 51 and rests on the side mold 40.

Generally, a cold cathode fluorescent lamp (CCFL) is used as the lamp unit 50. However, an external electrode fluorescent lamp (EEFL) may be used instead. The EEFL has characteristics of high brightness, low cost and low-consuming electric power and is driven with a single inverter (not shown). Further, a surface light source such as a flat fluorescent lamp (FFL) may be used. A surface light source shines on the surface and generates light that does not have the thickness.

A surface light source has high brightness, high brightness uniformity, and a long life and is more power efficient compared to other light sources.

The side mold 40 has two or three steps on its surface and is hollow inside. As shown, two side molds 40 are disposed at parallel edges of the bottom casing 90. The side mold 40 has an inserting groove 41 that is useful for coupling with the lamp 51, and holds the lamp supporting part 53. The side mold 40 also supports the optical sheet 30.

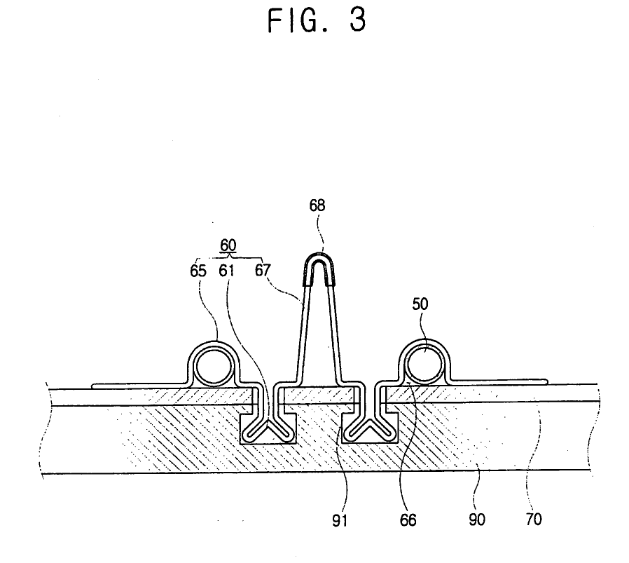

As shown in FIG. 3, the lamp supporting member 60 is made with a bent wire and comprises a fixing part 61 and a lamp holder 65. The fixing part 61 is inserted into a mounting part 91 of the bottom casing 90. The lamp holder 65 extends from the fixing part 61 and accommodates and supports the lamp unit 50. An opening 66 is created by the lamp holder 65 and the bottom casing 90. As shown, the lamp unit 50 is inserted into the lamp holder 65 through the opening 66. The lamp holder 65 partially accommodates and partially encompasses a circumference of the lamp unit 50 to hold the lamp unit 50 against the reflecting sheet 70. The lamp holder 65 is shaped into a loop with an open portion. The lamp supporting member 60 also includes a lamp supporting part 67 protruding to support the optical sheet 30.

The lamp supporting part 67 protrudes toward the optical sheet 30 to prevent the optical sheet 30 from sagging. An end portion of the sheet supporting part 67 supports the optical sheet 30 by contacting with the optical sheet 30 to hold it up. If the end portion of the sheet supporting part 67 is sharp or rough, the optical sheet 30 may be scratched by the end portion of the sheet supporting part 67 when the LCD 1 is shaken by an external impact. To prevent this type of scratch, it is preferable to make the tip of the sheet supporting part 67 round. Further, it is preferable to coat the tip of the sheet supporting part 67 with a coating layer 68, which includes a soft material like rubber. The lamp supporting member 60 of the wire type may be entirely coated with soft material like rubber and include a reflecting layer to reflect light. Preferably, the reflecting layer is made of the same material as the reflecting sheet 70 to uniformly reflect the light.

As shown in FIG. 1, a plurality of the wire-type lamp supporting members 60 are disposed on the lamp unit 50. In the embodiment shown, the wire-type lamp supporting member 60 is designed to support a pair of lamps 51 in the lamp unit 50. The lamp supporting member 60 is made of one wire, which is bent to support two lamps 51 and combine them with the bottom casing 90. However, this is not a limitation of the invention and in some embodiments, the lamp supporting member 60 for the pair of lamps 51 in the lamp unit 50 may be made of multiple wires. The lamp supporting member 60 may include one or more of metal, ceramic, and plastic that are strong enough to efficiently support the lamp unit 50 and to be securely fixed to the bottom casing 90.

In some embodiments, the lamp supporting member 60 is fixed to the bottom casing 90 by a bonding agent or the like.

The reflecting sheet 70 is disposed between the lamp unit 50 and the bottom casing 90 and reflects light from the lamp unit 50 to direct it toward the diffusion sheet 35. The reflecting sheet 70 includes polyethylene terephthalate (PET) or polycarbonate (PC). The reflecting sheet 70 adheres to a surface of the bottom casing 90 and includes a hole through which the fixing part 61 extends. The hole is positioned to align with the mounting part 91 of the bottom casing 90.

The bottom casing 90 has a plurality of the mounting parts 91 into which the fixing part 61 of the lamp supporting member 60 is inserted. The bottom casing 90 receives the backlight unit 80. The mounting part 91 is formed in the bottom surface, the side wall, or both of the bottom casing 90.

The top casing 5 has a window to expose a displaying scope of the LCD panel 10 and is coupled with the bottom casing 90.

The operation of the LCD according to the first embodiment of the present invention will now be described.

Since the lamp supporting member 60 is made of a wire, the area where light from the lamp unit 60 is blocked is significantly reduced when compared to a conventional lamp supporting member. Accordingly, light efficiency and brightness uniformity are improved.

As the LCD 1 becomes slimmer and lighter, the space between the lamp unit 50 and the optical sheet 30 becomes smaller. If the conventional lamp supporting member is used, the area where light from the lamp unit 50 is blocked becomes large due to the thickness of the conventional lamp supporting member and the brightness uniformity decreases. With a thick conventional lamp supporting member, the shape of the lamp supporting member sometimes appears on the screen to generate undesirable shades. However, if the wire-type lamp supporting member 60 of the first embodiment of the present invention is used, the light efficiency and the brightness uniformity are not compromised since the area where the light from the lamp unit 50 is blocked is small. The reduction in the light-blocked area is achieved even if the LCD is made slim. Because the area of the lamp supporting member 60 itself is small in the invention, the shape of the lamp supporting member 60 does not appear or almost does not appear on the screen.

The lamp supporting member 60 may be made of metal, ceramic, and/or plastic that is strong enough to effectively withstand any external impact. Further, the lamp holder 65 may partly rest on the lamp 51 without causing any damage to the lamp 50 because the lamp holder 65 is light and simple in structure. The fact that the lamp holder 65 can partly rest on the lamp 51 improves work efficiency in a module assembly process.

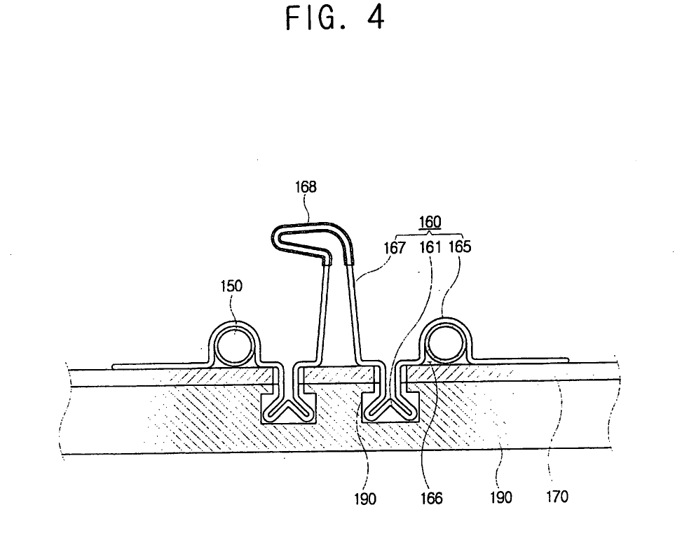

Hereinafter, a second embodiment of the present invention will be described with reference to FIG. 4. The second embodiment of a lamp supporting member 160 includes a sheet supporting part 167, a fixing part 161, and a lamp holder 165. A mounting part 190, an opening 166, a bottom casing 190, and a reflecting sheet 170 are substantially the same as the mounting part 91, the opening 66, the bottom casing 90, and the reflecting sheet 70 described above.

As shown in FIG. 4, the tip of the sheet supporting part 167 is bent by approximately 90° so that it forms a “flat” portion that extends parallel to the surface of an optical sheet. This bent-tip design prevents the optical sheet from being scratched by the sheet supporting part 167 upon receiving an external impact. Preferably, at least the tip of the sheet supporting part 167 is coated with a coating layer 168 which contains a soft material like rubber. In some embodiments, the entire lamp supporting member 160 may be coated with a soft material.

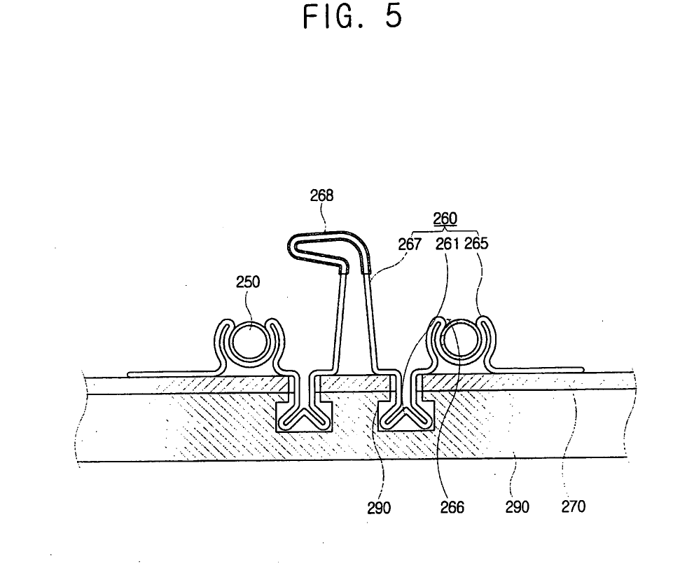

Hereinafter, a third embodiment of the present invention will be described with reference to FIG. 5. The third embodiment of a lamp supporting member 160 includes a sheet supporting part 267, a fixing part 261, and a lamp holder 265. A mounting part 290, an opening 266, a bottom casing 290, and a reflecting sheet 270 are substantially the same as the mounting part 91, the opening 66, the bottom casing 90, and the reflecting sheet 70 described above.

FIG. 5 is a sectional view of a main part of an LCD showing the lamp holder 265. As shown in FIG. 5, the lamp holder 265 is a loop with the opening 266 formed at the top, which is the part of the lamp holder 265 that is farthest from a bottom casing 290. The opening 266 is on the part of the lamp holder 265 that is closest to an optical sheet, and a lamp unit 250 is inserted into the lamp holder 265 through the opening 266. The lamp supporting member 260 is fixed to the bottom casing 290, and the lamp unit 250 is placed in the loop of the lamp holder 265. The particular design of the lamp supporting member and the arrangement of the lamp unit 50 enhances work efficiency in a module assembly process. The tip of a sheet supporting part 268 is preferably coated with a coating material 268 that is unlikely to scratch the optical sheet, similarly to the second embodiment described above.

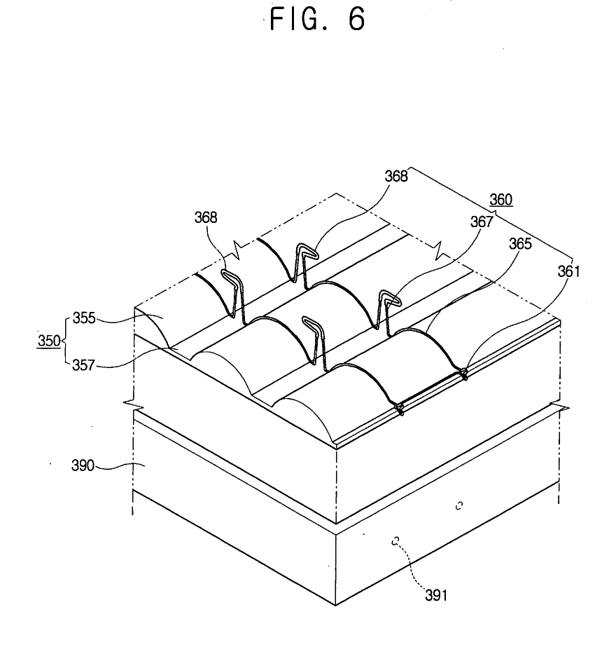

Hereinafter, a fourth embodiment of the present invention will be described in reference to FIG. 6. FIG. 6 shows how to apply a lamp supporting member 360 to a lamp unit 350 of a surface light source. As shown in FIG. 6, an upper surface of the surface light source 350 includes a light emitting area 355 with a wave pattern or an embossing pattern and a partitioning area 357 disposed between the light emitting areas 355. The light emitting area 355 emits light but the partitioning area does not.

The lamp supporting member 360 is disposed so that it extends in a direction that is perpendicular to the length of the surface light source 350. The lamp supporting member 360 has a lamp holder 365 placed on the light emitting area 355 and a sheet supporting part 367 protruding from the partitioning area 357 toward an optical sheet (see FIG. 1). The tip of the sheet supporting part 367 is bent to extend in a direction parallel to a surface of the optical sheet and is coated with a coating material 368.

The lamp supporting member 360 also includes a fixing part 361 that extend substantially laterally from a bottom casing 390 to combine with a mounting part 391 on the bottom casing 390. As shown, the mounting part 391 is formed on a side surface of the bottom casing 390.

In the case of the surface light source 350, it is preferable to provide the mounting part 391 on a side surface of the bottom casing 390, as opposed to on a bottom surface as in other embodiments. The reason is because the surface light source 350 is shaped like a flat-plate and fills the inner space of the bottom casing 390, making it difficult to form the mounting part 391 on the bottom surface of the bottom casing 390. Since the surface light source 350 covers substantially the entire bottom surface of the bottom casing 390, the mounting part 391 is formed on the side surface of the bottom casing 390 and the fixing part 361 is inserted into the mounting part 391 to fix the lamp supporting member 360.

The wire-type lamp supporting member 360 according to the present invention does not block light from the surface light source 350, thereby improving light efficiency and brightness uniformity. The wire-type lamp supporting member 360 also prevents the shape of the lamp supporting member 360 from being visible from outside the screen because it is thinner than a conventional lamp supporting member.

Although a few embodiments of the present invention have been shown and described, it will be appreciated by those skilled in the art that changes may be made in these embodiments without departing from the principles and spirit of the invention, the h scope of which is defined in the appended claims and their equivalents.

1. A liquid crystal display (LCD) comprising:
an LCD panel forming an image;
a lamp unit irradiating the LCD panel;
a bottom casing capable of receiving the lamp unit and having a mounting part; and
a lamp supporting member including:
a lamp holder made of a wire shaped into a partial loop to hold the lamp unit; and
a fixing part configured to be coupled with the mounting part.

2. The LCD according to claim 1, further comprising an optical sheet disposed between the LCD panel and the lamp unit, wherein the lamp supporting member further comprises a sheet supporting part protruding toward the optical sheet to support the optical sheet.

3. The LCD according to claim 2, wherein a tip of the sheet supporting part is bent to extend in a direction parallel to a surface of the optical sheet.

4. The LCD according to claim 3, wherein the tip of the sheet supporting part is coated with a coating material.

5. The LCD according to claim 1, wherein the lamp holder comprises an opening in the loop.

6. The LCD according to claim 5, wherein the opening is formed in a part of the loop closest to the bottom casing.

7. The LCD according to claim 5, wherein the opening is in a part of the loop closest to the LCD panel.

8. The LCD according to claim 1, wherein the lamp supporting member is configured to fit with a pair of lamps in the lamp unit.

9. The LCD according to claim 8, wherein the lamp supporting member comprises a single piece of wire that is bent to hold the pair of lamps in the lamp unit.

10. The LCD according to claim 1, wherein the fixing part is formed in at least one of a bottom surface and a side wall of the bottom casing.

11. The LCD according to claim 1, wherein the lamp supporting member comprises one of metal, ceramic, and plastic.

12. The LCD according to claim 1, wherein the lamp unit comprises a surface light source.

13. The LCD according to claim 1, wherein the lamp unit comprises an external electrode fluorescent lamp.

14. A liquid crystal display (LCD) comprising:
a lamp unit;
a bottom casing having a mounting part; and
a lamp supporting member made of a single piece of wire, wherein the single piece of wire is bent to form a loop for holding the lamp unit and a fixing part to securely attach to the mounting part.

15. The LCD of claim 14, wherein the mounting part is an opening extending through the bottom casing and the fixing part is a segment of the wire shaped to fit into the opening.

16. The LCD of claim 15, wherein the opening becomes wider away from a surface of the bottom casing.

17. A method of making a liquid crystal display (LCD), the method comprising:
providing a lamp unit;
providing a bottom casing having a mounting part; and
fixing the lamp unit to the bottom casing by using a lamp supporting member made of a single piece of wire, wherein the single piece of wire is bent to form a loop for holding the lamp unit and a fixing part to securely attach to the mounting part.
